(19) United States
(12) Patent Application Publication
(10) Pub. No.: US 2024/0002069 A1
(43) Pub. Date: Jan. 4, 2024

(54) INTELLIGENT, STEERABLE, AND CONFIGURABLE LIGHT FOR AIRCRAFT

(71) Applicant: WHELEN ENGINEERING COMPANY, INC., Chester, CT (US)

(72) Inventors: Matt DONDONEAU, Horace, ND (US); Tyler WHEELER, Vero Beach, FL (US)

(73) Assignee: WHELEN ENGINEERING COMPANY, INC., Chester, CT (US)

(21) Appl. No.: 18/216,455

(22) Filed: Jun. 29, 2023

Related U.S. Application Data
(60) Provisional application No. 63/357,846, filed on Jul. 1, 2022.

(51) Int. Cl. B64D 47/04; F21S 41/663; F21S 45/40; F21S 41/20

(52) U.S. Cl. CPC B64D 47/04; F21S 41/663; F21S 45/40; F21S 41/285; F21Y 2115/10

(57) ABSTRACT

A fixed lighting assembly that is able to change between configurations, including from a floodlight to a spotlight and any configuration in between, allows for a substantial improvement in performance and safety of a vehicle. Additionally, the fixed lighting assembly includes the capability for the light beam to move across one or more axis to steer the light to a desired direction without the use of moving parts. Instead, the steering is performed using lenses, strategically placed LEDs, optics, and associated drivers to illuminate different areas and create a variety of beam shapes. Additionally, the brightness or intensity of the beam can also be changed without using moving parts. A control module may be used to automatically configure these changes. The fixed lighting assembly may be manually controlled to change to one or more preconfigured modes, such as a spotlight mode, flood light mode, landing mode, taxiing mode, etc.

### CROSS-REFERENCE TO RELATED APPLICATIONS

This application claims priority to and the benefit of U.S. Provisional Application No. 63/357,846, titled “INTELLIGENT, STEERABLE, AND CONFIGURABLE LIGHT FOR AIRCRAFT,” filed Jul. 1, 2022, the full disclosure of which is hereby incorporated by reference in its entirety for all purposes.

### BACKGROUND

During the operation of aircraft and other vehicles, lighting is important for both navigation and identification. Lighting units have traditionally been manually controlled and have required separate lighting units for spotlights and for wide-angle lights. Additionally, most lights are stationary while the area that needs to be illuminated may move, or the lights need to be relocated during movement of the vehicle to maintain the proper viewing area.

### BRIEF DESCRIPTION OF THE DRAWINGS

Various embodiments in accordance with the present disclosure will be described with reference to the drawings, in which:

FIGS. 1A and 1B illustrate an example of a lighting unit, according to at least one embodiment;

FIGS. 1C and 1D illustrate an example of a lighting unit, according to at least one embodiment;

FIGS. 2A and 2B illustrate an example of another lighting unit, according to at least one embodiment;

FIG. 3 illustrates the operation of lighting unit equipped to an airplane, according to at least one embodiment;

FIG. 4 illustrates the operation of a lighting unit equipped to an airplane, according to at least one embodiment; and

FIGS. 5A, 5B, and 5C illustrate the operation of a lighting unit equipped to a helicopter, according to at least one embodiment.

### DETAILED DESCRIPTION

Approaches in accordance with various embodiments can provide for improved operation of aircraft lighting, as well as applications in other vehicles and applications, with a fixed lighting assembly without moving parts. In particular, some examples use improved light housings and orientations to enable altering the directions the light is projected to, the width of the beams, as well as the intensity of the light emitted. These changes can be controlled manually or automatically, depending on the condition of the vehicle and the environment. The light can be switched into predetermined modes either automatically our selecting the mode by a user, and can be selected based on user preference, operational necessity, or for emergency use.

A fixed lighting assembly that is able to change between configurations, including from a floodlight to a spotlight and any configuration in between, allows for a substantial improvement in performance and safety of a vehicle. Additionally, the fixed lighting assembly includes the capability for the light beam to move across one or more axis to steer the light to a desired direction without the use of moving parts. Instead, the steering is performed using lenses, strategically placed LEDs, optics, and associated drivers to illuminate different areas and create a variety of beam shapes. Additionally, the brightness or intensity of the beam can also be changed without using moving parts. A control module may be used to automatically configure these changes. The fixed lighting assembly may be manually controlled to change to one or more preconfigured modes, such as a spotlight mode, flood light mode, landing mode, taxiing mode, etc. The preconfigured modes may be chosen automatically, or may be chosen using a dedicated switch by the user, therefore bypassing the control module. Depending on the situation, selection of the mode may be performed based on user preference, operational necessity, emergency use, or any other suitable condition.

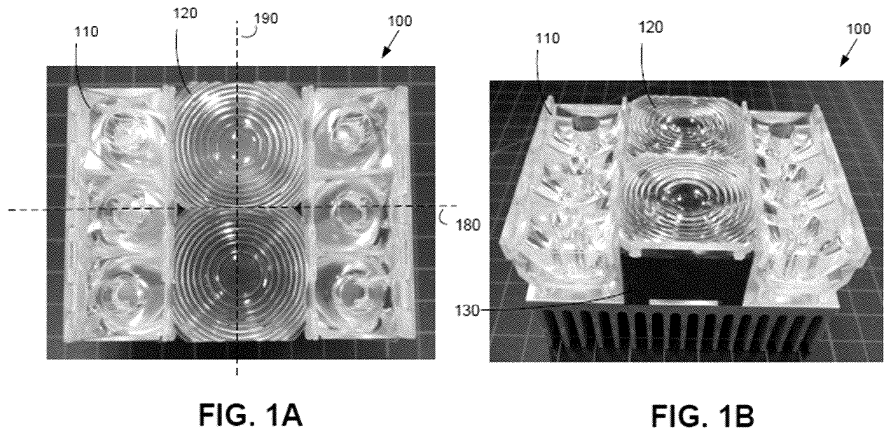

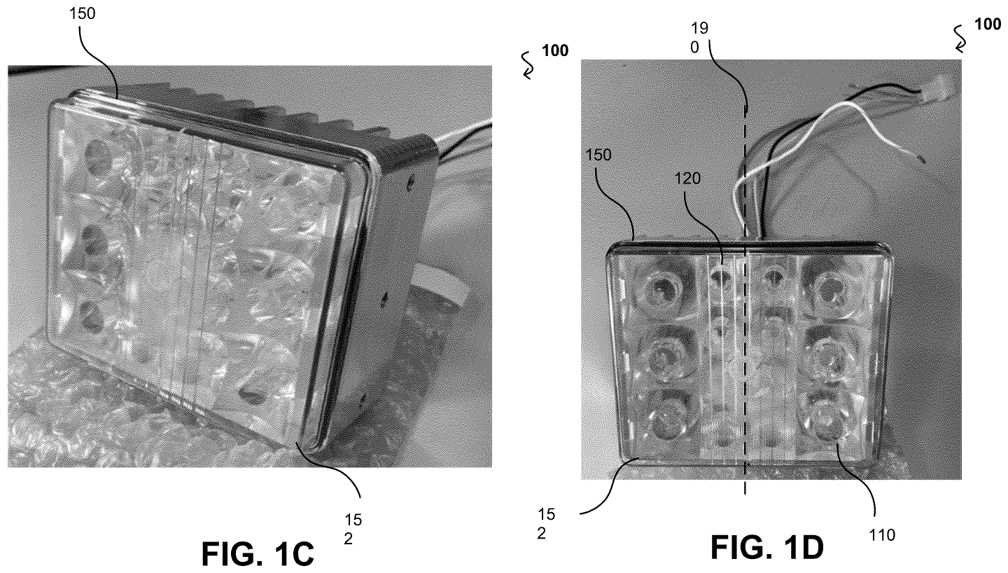

Referring to FIGS. 1A and 1B, lighting unit 100 may use a combination of LEDs (light emitting diodes), LED dies, optics, and/or lenses to focus light in different directions where illumination is desired. Lighting unit 100 is configured to switch one or more LEDs contained within lighting unit 100 on or off, or modify the intensity of one or more LEDs to alter the direction light is projected through the lenses and optics. Utilizing this method of adjusting the output in this manner projects the light in a variety of beam widths and intensities depending on the optics and lenses involved. This will appear to a user that the light has changed modes, such as from a spotlight to a flood light, or some other form. Further, lighting unit 100 is capable of controlling the projected light to only illuminate one side of a complete axis by using a combination of LED intensities. For example, if lighting unit 100 is controlled to move the light from one extreme of an axis to the other extreme of the axis by increasing and decreasing the intensities of the light-emitting components, the projected light will appear to move or steer across that axis.

Lighting unit 100 is steerable and changeable between two or more modes. By way of example, modes may include a wide mode or a spot mode, among other options, such as a straight mode or a steering mode. In the straight mode, for example, one or more lights (e.g., lighting components, lighting devices, etc.) may be illuminated with a given intensity. However, in a steering mode, one or more lights may be illuminated with varying intensity along a particular direction, which may direct or otherwise focus the light in a particular direction while certain other lights are not illuminated or may be illuminated with a reduced intensity. Lighting unit 100 can be developed for use with an airplane or other flying device, and may be developed with both a landing light feature and a taxiing light feature. Lighting unit 100 is also steerable, allowing illumination across one or more axes. It should be appreciated that while embodiments may describe an airplane or a flying device, the present disclosure is not limited to such uses or configurations and may be used in a wide variety of applications, such as automobiles, fixed lighting systems, such as security or home lightings, and the like. Lighting unit 100 is configurable to allow for illumination ranging from a wide beam to a narrow spotlight beam, as well as other configurations. This ability to change configurations through the use of an adjustable beam allows for even more variations in directionality. The directionality allows for lighting unit 100 to put more light where it is needed, focusing light in a more efficient manner. It is therefore possible to concentrate more output in a single direction. Additionally, lower heat and lower amperage, or equal heat and equal amperage are achieved compared to a traditional lighting unit, but lighting unit 100 will also be able to send the light in different directions. Example embodiments regarding the adjustable beam are disclosed in Applicant's allowed U.S. Pat. No. 10,420,177, filed on Dec. 19, 2016, entitled “LED ILLUMINATION MODULE WITH FIXED OPTIC AND VARIABLE EMISSION PATTERN”, the entire disclosure of which is incorporated by reference herein. Additional example embodiments regarding the adjustable beam are disclosed in Applicant's allowed U.S. Pat. No. 10,400,994, filed on Dec. 19, 2016, entitled “LED ILLUMINATION MODULE WITH FIXED OPTIC AND VARIABLE EMISSION PATTERN”, the entire disclosure of which is incorporated by reference herein.

Lighting unit 100 is configured to steer the light beam across the at least one axis, such as a horizontal axis 180 or a vertical axis 190. Lighting unit 100 is able to project light to the left, to the right, and any position in between along the axis. Furthermore, with respect to vertical axis 190, lighting unit 100 may project lights to the top, to the bottom, or any positions in between. Having lighting unit 100 connected with a controller or a dedicated switching input, the light beam could be coupled with the steering of the aircraft while taxiing, on an airport surface, such as a runway. In certain instances, if the aircraft includes multiple lighting units 100, certain units could be paired with the steering of the aircraft, while other lighting units 100 could be directed in front of the aircraft. Coupling lighting units 100 with the steering of the aircraft allows the light to turn left or right as needed and illuminate an area of desired travel by a pilot without needing to manually direct the aircraft lighting system or change the direction of the airplane simply to illuminate a desired area.

Lighting unit 100 is contemplated to include one or more LEDs, LED dies, or other suitable light emitting components. Additionally, lighting unit 100 may include positioned optics and/or lenses that are able to project light to different areas. The light emitting source may be LED, high intensity discharge (HID), incandescent, or other suitable lighting source and may include visible, infrared, and/or other wavelengths. The optics may consist of polycarbonate, silicon, or any other suitable material, and lenses may be clear, diffused, parabolic, Fresnel, or other suitable design. Lighting unit 100 may also include firmware responsible for directing the lighting intensity adjustments and for interacting with and receiving commands via CAN bus, or other suitable methods, from a lighting controller. Additionally, lighting unit 100 may have the ability to perform an authentication with a control module to verify compatibility.

Still referring to FIGS. 1A and 1B, lighting unit 100 is steerable across at least one axis. Lighting unit 100 has one or more high powered landing lights 110 (e.g., outside lights) located on the outside edge of lighting unit 100. Further, the interior lights 120 of lighting unit 100 comprise one or more Fresnel lenses or optics with fluted or diffused lenses, which are generally wide, taxiing lights. Multiple light emitting 130 elements are located under the Fresnel, fluted, or diffused lens. Other lens elements may be located on the outer edges of lighting unit 100. By selectively activating certain LEDs and increasing or decreasing the illumination of individual lights, the beam from the lights can be steered. By incorporating LED dies, lighting unit 100 can selectively illuminate portions of the one or more LED dies to move the beam of light across an axis in a smoothly steerable fashion. Additionally, the intensity of the beam of light can be controlled as well. The optics may be a single piece injection. Additionally, a silicon injected lens may be configured to be part of lighting unit 100. For example, one or more portions of the lighting unit 100 may incorporate or otherwise utilize silicon injected lens components, which may be integral to or injected into a body.

Referring to FIGS. 1C and 1D, lighting unit 100 may be arranged within a housing 150 that may include a cover 152 arranged over the landing lights 110 and/or the interior lights 120. In this example, the cover 152 includes a flat or planar face, but it should be appreciated that a shape of the cover 152 and/or cover face may be a variety of different shapes. Furthermore, in the example of FIGS. 1C and 1D, the interior lights 120 are illustrated as a collection of elements arranged vertically along the axis 190 in two separate columns. The example shows 8 lighting elements, but it should be appreciated that more or fewer may be included within the scope of the present disclosure.

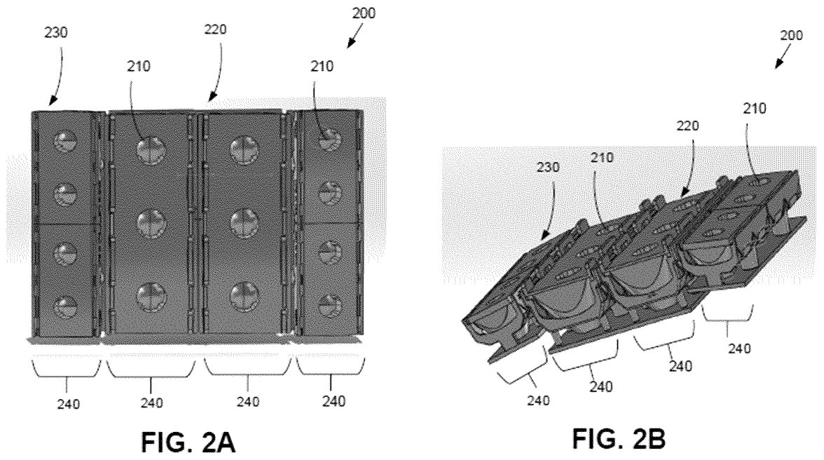

Referring now to FIGS. 2A and 2B, lighting unit 200 incorporates one or more total internal reflection (TIR) lenses to collimate LED light into one or more well-controlled light beams. It should be appreciated that various of TIR lenses may be utilized with the present disclosure, including but not limited to, spot TIRs, diffused TIRs, oval TIRs, wide TIRs, and the like. Specifically, lighting unit 200 includes two stacks 240 of three TIRs 210 in the interior 220 of lighting unit 200, and includes two stacks 240 of four TIRs 210 on the exterior 230 of lighting unit 100 to the right and left of the interior 220 stacks 240. However, more or fewer stacks 240 may be used and similarly, more or fewer TIRs 210 in each stack 240 may be used in lighting unit 200. The LEDs of lighting unit 200 can be pre-aimed at different angles. Additionally, the beam produced by lighting unit 200 can move up, down, left and right. While most aircraft lights are able to create a beam that illuminates straight ahead, lighting unit 200 can be steered in one or more directions. The illumination may lose some intensity when the beam is steered in a direction away from center, but the utility of the directed beam may be more effective than the center-facing beam. While a Fresnel lens is able to provide some measure of light modulation in multiple directions, a controller is able to provide a larger degree of steerable capability. It should be appreciated that the stacks 240 of FIGS. 2A and 2B may be incorporated with the housing 150 shown in FIGS. 1C and 1D.

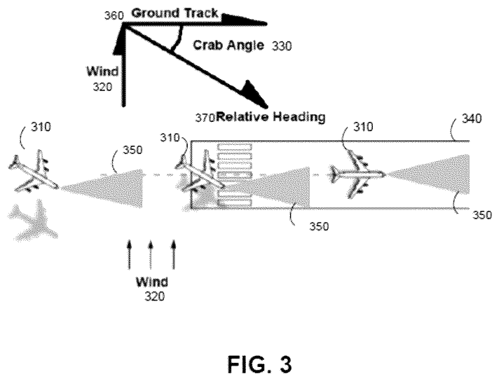

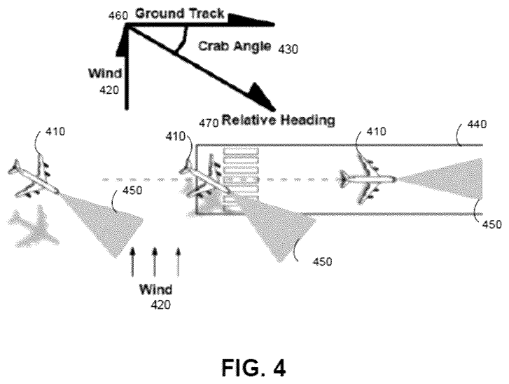

Referring now to FIGS. 3 and 4, lighting unit can improve the ability to safely operate aerial vehicles. For instance, while landing an airplane 310 or other vehicle, a crosswind can turn the vehicle into the wind 320, causing the vehicle to fly at an angle 330, commonly known as the crab angle, to a relative heading 370 away from the runway 340 just before it lands on runway 340. In this situation, lighting unit can, automatically or manually, change the direction of beam 350 from directly in front of the nose of the vehicle 310, or along relative heading 370, to the ground track 360 direction the vehicle is flying, at an angle 330 to relative heading 370 of the plane. This would allow the pilot of the aircraft 310 to maintain visual contact with the runway 340, instead of only having illumination in front of the nose of the vehicle 310. In an aircraft 410 with traditional, forward-facing only lights, the beams 450 of light would only highlight along the relative heading 470, an area to the side of the desired landing area of the runway 440 as the wind 420 causes aircraft 410 to turn at crab angle 430. Lighting unit would allow the beam 450 to be directed as needed in the direction of ground track 460 to account for the change on angle 430 of the aircraft 410 so the landing area or runway 440 can still be seen by the pilot. In certain instances lighting unit may replace the lights located on the front and wingtips of an aircraft, therefore providing illumination in front of the plane and allowing for recognition of the plane during takeout, landing, and taxiing. This configuration would allow for the replacement of at least five different lights generally included on an aircraft, including wingtip landing, wingtip recognition, and taxi mode front light. Replacing these five lights with two lighting units would provide the same or better light output. Additionally, using two or more lighting units allows for improved redundancy. For example, if one of the two lighting units go out, the system will be able to sense this and will canter the other light to steer it towards the middle of the aircraft to overcome the deficit.

Still referring to FIGS. 3 and 4, data collected from the aircraft in flight could be used to steer a light beam 350 along the horizontal axis to the left or right of the aircraft's centerline. One application for this would be during crosswind landing operations as discussed above. While an aircraft 310 is approaching a runway 340 that is not aligned with the prevailing wind 420, the aircraft must be steered at an appropriate angle 330 into the wind 320. The difference from the direction of the aircraft's longitudinal axis, or the relative heading 370, and the direction of the runway 340 is the crab angle 330, as shown. When this occurs, the aircraft 310 will follow a path over the ground, ground track 360 that is ideally aligned with the runway 340. This information is generally readily available on the aircraft via a Flight Management System (FMS), Global Positioning System (GPS), or other sensors such as Inertial Measurement Units (IMU) or accelerometers and would be input to a control module. The control module would then calculate an input angle between the relative heading 370 and ground track 360 to send a command to steer the light 350 toward the runway 340. As shown in FIG. 4, under these same conditions, an existing, fixed aircraft 410 landing light 450 can only illuminate directly in front of the aircraft 410 along its relative heading 370. Therefore, lighting unit illuminates the runway 440 much earlier that is currently allowed with the fixed landing light, only able to illuminate the relative heading 370.

Lighting unit can also be employed during taxiing of an aircraft. In certain circumstances, the direction of light beam can be turned as the vehicle is turning during taxiing. In other circumstances, lighting unit can be aimed toward another aircraft while taxiing to provide improved recognition of the aircraft. It should be understood that many airplanes have separate lights for landing and for taxiing. In most instances, landing lights are spotlights and taxi lights are floodlights. Lighting unit could replace the two separate landing and taxiing light with one light feature. Additionally, landing lights are usually located out on the wing tips of the airplane and are not generally effective at illuminating in front of the airplane. However, lighting unit allows the beam to be steered toward the centerline of the airplane, in order to illuminate the area in front. For example, responsive to a signal, one or more lighting devices may have their intensity increased or decreased. By decreasing intensity to certain devices, but increasing the intensity in others, the beam will appear to shift or otherwise be directed toward the desired area. Such shifting may occur by adjusting a voltage applied to the lighting device, among other options. Therefore, the need for a separate front light on the airplane is removed. In examples where lighting unit is incorporated onto a helicopter, lighting unit can steer across different axes as well as needed.

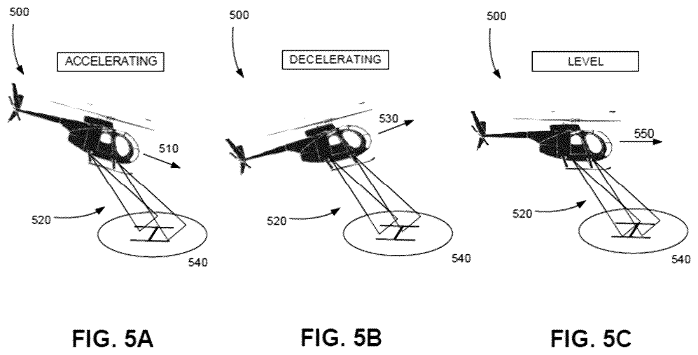

Referring now to FIGS. 5A, 5B, and 5C, a helicopter 500 comprises a lighting unit able to adjust or steer the projected light 520 along a vertical axis. In certain examples, this would be performed similarly to steering the light along a horizontal axis, but would be particularly useful for aircraft that have significant pitch (also called Angle of Attack or AOA) changes but need to maintain a constant angle of light 520, such as helicopter 500. Helicopters 500 generally drop the nose low to accelerate and raise the nose to decelerate. Therefore, as helicopter 500 approaches a landing zone 540, existing fixed lights either illuminate only fore or aft of the intended landing zone 540 as the aircraft 500 speeds up or slows down. Some helicopters 500 include adjustable landing lights that can be adjusted for these pitch changes, but are manually controlled and physically steered, adding to the pilots workload during this process. A lighting unit coupled with a control module connected to aircraft sensors as previously described can automatically make the adjustments for pitch changes, therefore reducing pilot workload. As shown in FIG. 5A, as helicopter 500 maintains a downward 510 approach, the beams 520 are automatically angled to illuminate landing zone 540. Similarly, as shown in FIG. 5B, as helicopter 500 maintains an upward 530 approach, the beams 520 are automatically angled to illuminate landing zone 540. Finally, as shown in FIG. 5C, as helicopter 500 maintains a level 550 approach, the beams 520 are still automatically angled to illuminate landing zone 540.

It is contemplated that directional steering of lighting unit is controlled by a control box. An automated controller is used to steer the beam of lighting unit. The automated controller is able to take input from the aircraft, which may be from avionics or from certain switches, such as a gear level or any other suitable input mechanism. Using the inputs, the automated controller can turn the lights on and off, steer the light, and perform any other available manipulation of lighting unit. For example, the control box may receive one or more signals from the aircraft, such as via a wired or wireless connection. By way of example, the control box may receive a signal indicative of the AOA of the aircraft and/or a signal regarding pitch changes. These signals may then be evaluated and converted to determine how to adjust illumination of the lighting devices of the lighting unit in order to maintain a desired output location. For example, a standard configuration may be established such that one or more beams is emitted at a particular angle, relative a vertical axis extending through a drive shaft. This particular angle may then be used to determine an illuminated area with respect to the one or more beams. Accordingly, adjustments to the aircraft position, such as a change in pitch, may be used to adjust the illumination of the lighting devices such that the illuminated area is maintained. One controller can control multiple lighting units on a vehicle, or each lighting unit on a vehicle may be controlled by a single controller. Without an operational input, lighting unit must be manually controlled by a switch or number of switches. Additionally, in the absence of a data input, lighting unit could be configured to operate in a safety mode, as determined by use case. Defaulting to a landing, or spotlight, mode is one exemplary example.

Lighting unit can be used with a lighting controller as disclosed in Applicant's filed U.S. patent application Ser. No. 17/172,826 filed on Feb. 10, 2021, entitled “Aircraft Lighting System and method,” the entire disclosure of which is incorporated by reference herein. The controller connected to lighting unit may receive avionics information and specific sensor information from the airplane, such as gear switch, throttle switch, or any other suitable sensor information. This information can be used to determine the operation of lighting unit at any given time, as well as enable steering of lighting unit according to the condition of the vehicle.

Lighting unit would be used with a combination of power inputs and/or Controller Area Network (CAN) bus controls to alter configurations during operation of the vehicle. The primary input to lighting unit would be via a constant power (+) and a common ground (−). A CAN hi/low pair of wires can then control lighting unit's mode via firmware on the light. Commands can be sent from a control module to lighting unit to adjust the output as desired. Additional dedicated power wires can deliver manual override control to lighting unit to “force” lighting unit to a manually selected state. Lighting unit may have 2 additional positive (+) wires for taxi (flood) or landing (spot) manual selections. The prioritization of these inputs can be configured via firmware on lighting unit to best suit the requirements of the vehicle. For safety, the landing (spot) manual selection utilizes circuitry to bypass any on-device microcontroller to ensure function in case of failure of the microcontroller.

Lighting unit may incorporate active cooling, which allows for illumination of all elements of lighting unit and higher, sustained output. For example, force-air cooling may be utilized to manage LED thermals, such as by including one or more fans within lighting unit to direct an air flow over different parts or over one or more finned heat sinks. Additionally, liquid cooling may be implemented, where a fluid (e.g., water, a refrigerant, etc.) may be pumped through tubing that is arranged proximate different components. Furthermore, passive cooling may also be utilized, such as various heat sinks. A Peltier cooler may be utilized.

Lighting unit may be produced in any number of designs in order to fit common aviation form factors. Lighting unit may fit it a common rectangular space. One size may include a width of four inches and a height of three and one fourth inches. However, lighting unit can be produced in any other form factor that may be required. Lighting unit may include standard aircraft round sizes commonly associated as PAR36, PAR46, and PAR64.

Additionally, lighting unit may be produced as any common size within the industry, or may be adapted to fit other unique sizes.

Lighting unit may include firmware and/or software in order to be fully operational. For example, the lighting unit may include different electronic components to facilitate operations, such as various processors or memories, which may be deployed as a system on chip (SoC) or in another implementation. Firmware may be utilized to initiate different aspects of the components and enable an operating system to load and execute one or more tasks. Various software systems may be deployed, which may be tuned or otherwise specified in accordance with a use case for the lighting unit. For example, different software implementations may be used for aerial vehicles as opposed to ground vehicles. Additionally, software may be utilized to allow other systems to communicate or otherwise interface with the lighting unit. The firmware and/or software may use wired CAN-based. Wireless CAN, ethernet, MOST, FlexRay or another suitable system may be used to control lighting unit.

The lighting unit may include six wires in the rear of the assembly to allow for operation. One wire is a common ground wire, a second wire is an aircraft ground wire, and two other wires are power wires, one for a taxi light switch and the other a landing light switch. The last two wires are small CAN bus wires which provide the instruction from the CAN controller to control the light output and enable steering of lighting unit. Other additional inputs may include an override for the pilot to switch on the taxi light state manually, or manually switch on the landing light.

It is contemplated that lighting unit may be suitable for use in a variety of applications where the ability to steer the light beam or vary the beam from a spotlight to a flood light may be beneficial. For example, lighting unit may be used in an automotive or marine application. Additionally, in examples where a larger lighting unit is used, directional control of the light beam may be across multiple axes, or to any specific coordinates within a given area. Further, lighting unit may be configured to be used for other lighting applications other than those that require forward illumination. The steering capability can be adapted to an aircraft position light or an aircraft anticollision light that is capable of being directed at or intensified to a specific direction when needed. Lighting unit can be used to intensify the lights on the aircraft as it becomes closer in proximity to another aircraft during flight, improving its visibility and therefore improving safety. Lighting unit can aim the projected beam toward another aircraft, regardless of proximity. Lighting unit can function as a steerable spotlight, both using the solid-state function as detail above or in conjunction with a mechanically steered base for greater range of motion. These features may also be utilized with any other type of vehicle including automobiles and marine vessels.

Lighting unit may be paired with a control module and optionally a mechanically steerable base. This steerable lighting capability may be used with a wireless tracking device, or other connected primary device, that pairs to the control module to aim or secondary lighting unit to the primary device. One application for this feature includes a fleet of aircraft to interconnect all of lighting units on every plane controlled by a single controller device. A further application includes a helmet-mounting cueing system for an aircraft pilot, such as a helicopter pilot, to point lighting unit in the direction the helmet is facing. This would provide a hands-free method of illuminating what the pilot is looking at in an automatic and intuitive manner. It is possible to position lighting unit at a traffic stop or other scene, where a police officer or emergency worker may wear a tracker that wirelessly connects to the control module. The control module may be located in a vehicle or another suitable location, such as one with a power source. The user may be able to wirelessly connect one or more lighting units to the controller. Lighting unit may operate in accordance with any number of programmed modes. One such mode may include tracking the police officer with a spotlight, keeping the officer and the surrounding area illuminated without further input from the user.

Various embodiments may be directed toward a steerable, changeable lighting device that may be incorporated into one or more mounting locations, such as locations associated with a movable vehicle (e.g., an aerial vehicle, a marine vehicle, a ground vehicle) or to a fixed location (e.g., a pole, a building, a structure, etc.). Such a system would provide a lighting unit that can operate in multiple operation modes, such as either a wide or a spot mode, while also introducing directionality of a light beam without incorporating additional moving parts, thereby simplifying operations, improving reliability, and enabling integration into a wider variety of locations. As a result, a greater percentage of a light output can be concentrated in a single direction or toward a single location responsive to one or more instructions, while still permitting operation in a wide or non-focused mode in other instances. Moreover, embodiments provide for lower heat, lower amperage operations.

Embodiments may be directed toward a lighting unit that includes one or more different lighting devices, which may include a set or array of LEDs, among other options. A control system may be utilized to steer or otherwise control light emission for the lighting unit, such that different intensities may be used at different lighting devices based on a given situation. For example, if the lighting unit had three columns of lights, to illuminate toward a far right side, the left column would be dimmed, the middle column would maintain an illumination level, and the right column may increase its illumination level. An emitted bream from the lighting unit would then appear to steer toward the right due to the adjustment in intensities for the lighting devices forming the units. It should be appreciated that various embodiments may also incorporate different lens configurations, among other design options, in order to further steer or otherwise focus light in a desired location. Accordingly, different columns or rows of lights, or individual lighting devices, may be pre-aimed or otherwise configured to direct a light beam in a predetermined position, and then based on a set intensity and/or behavior of associated lighting devices, may be used to steer or otherwise direct beams in a desired direction.

Various embodiments may enable a lighting unit that includes an LED die with a number of lighting devices or lighting elements spaced throughout the die. Optics associated with the die may be of a single piece injection, such as a single piece silicon injected lens. This die may then be incorporated into the unit that may include different dimensions or form factors based, at least in part, on a desired application. For example, different packages may include different components based on expected operating conditions, thereby enabling streamlined products for their particular applications.

What is claimed is:

1. A steerable lighting unit, comprising:
a housing, at least a portion of the housing including one or more light emitting diode (LED) dies;
one or more lighting elements arranged within the housing, the one or more lighting elements having adjustable intensities responsive to an input signal; and
a control unit to provide a control signal to the one or more lighting elements to adjust respective intensities, the respective intensities being adjusted such that a direction of an emitted light beam is changed responsive to an input lighting configuration.

2. The steerable lighting unit of claim 1, wherein the one or more lighting elements are at least one of an LED, a high intensity discharge (HID) bulb, or an incandescent bulb.

3. The steerable lighting unit of claim 1, wherein the direction of the emitted light beam is steerable across an axis of the housing.

4. The steerable lighting unit of claim 3, wherein the axis is a vertical axis or a horizontal axis.

5. The steerable lighting unit of claim 1, wherein the control unit is configured to receive one or more control inputs from a vehicle associated with the steerable lighting unit, the vehicle including at least one of an aerial vehicle, a marine vehicle, or a ground vehicle.

6. The steerable lighting unit of claim 1, wherein the input lighting configuration reduces a first intensity of at least one lighting element and increases a second intensity of at least one lighting element.

7. The steerable lighting unit of claim 1, further comprising:
a cover positioned over the one or more lighting elements arranged within the housing, a curvature of a cover face being different from at least one of the LED dies.

8. A steerable lighting unit, comprising:
a housing, at least a portion of the housing including one or more total internal reflection (TIR) lenses;
one or more lighting elements arranged within the housing, the one or more lighting elements having adjustable intensities responsive to an input signal; and
a control unit to provide a control signal to the one or more lighting elements to adjust respective intensities, the respective intensities being adjusted such that a direction of an emitted light beam is changed responsive to an input lighting configuration.

9. The steerable lighting unit of claim 8, wherein one or more of the lighting elements are pre-aimed to direct light in a pre-determined direction.

10. The steerable lighting unit of claim 8, wherein the one or more TIR lenses are arranged in stacks.

11. The steerable lighting unit of claim 8, wherein the direction of the emitted light beam is steerable across an axis of the housing.

12. The steerable lighting unit of claim 11, wherein the axis is a vertical axis or a horizontal axis.

12. The steerable lighting unit of claim 8, wherein the control unit is configured to receive one or more control inputs from a vehicle associated with the steerable lighting unit, the vehicle including at least one of an aerial vehicle, a marine vehicle, or a ground vehicle.

14. The steerable lighting unit of claim 8, wherein the input lighting configuration reduces a first intensity of at least one lighting element and increases a second intensity of at least one lighting element.

15. The steerable lighting unit of claim 1, further comprising:
a cover positioned over the one or more lighting elements arranged within the housing, a curvature of a cover face being different from at least one of the LED dies.

16. A method, comprising:
determining a relative heading of an aircraft with respect to a ground track;
determining a crab angle between the relative heading and the ground track; and
adjusting a direction of a light beam emitted from one or more lighting elements based, at least in part, on the crab angle.

17. The method of claim 16, further comprising:
adjusting a first intensity of a first lighting element of the one or more lighting elements; and
adjusting a second intensity of a second lighting element of the one or more lighting elements.

18. The method of claim 17, wherein the first intensity is increased and the second intensity is decreased.

19. The method of claim 16, wherein adjusting the direction of the light beam corresponds to steering the light beam across an axis of a lighting unit arranged at a nose of an aircraft.

20. The method of claim 16, wherein adjusting the direction of the light beam is responsive to receipt of one or more control inputs from a vehicle associated with a steerable lighting unit, the vehicle including at least one of an aerial vehicle, a marine vehicle, or a ground vehicle.
